(19) United States
(12) Patent Application Publication
(10) Pub. No.: US 2017/0147465 A1
(43) Pub. Date: May 25, 2017

(54) ELECTRONIC APPARATUS AND PERIPHERAL APPARATUS

(71) Applicant: TOSHIBA TEC KABUSHIKI KAISHA, Tokyo (JP)

(72) Inventor: Mikihiro Kanomata, Izunokuni Shizuoka (JP)

(21) Appl. No.: 15/353,851

(22) Filed: Nov. 17, 2016

(30) Foreign Application Priority Data
Nov. 25, 2015 (JP) 2015-229800

(51) Int. Cl. G06F 11/30

(52) U.S. Cl. CPC G06F 11/3051; G06F 11/3041

(57) ABSTRACT

An electronic apparatus of an embodiment includes a first connector including a plurality of terminals including a detection signal output terminal for outputting a detection signal and an identification signal input terminal for receiving an identification signal; a connection cable connecting the detection signal output terminal and the identification signal input terminal to a corresponding terminal of a peripheral apparatus by cross wiring; and a control unit that monitors an input signal of the identification signal input terminal by supplying the detection signal to the detection signal output terminal, and starts signal transmission or electrical power transmission through a remaining terminal in a condition where the identification signal is input to the identification signal input terminal based on the detection signal.

### CROSS-REFERENCE TO RELATED APPLICATIONS

This application is based upon and claims the benefit of priority from Japanese Patent Application No. 2015-229800, filed Nov. 25, 2015, the entire contents of which are incorporated herein by reference.

### FIELD

Embodiments described herein relate generally to an electronic apparatus and a peripheral apparatus and methods related thereto.

### BACKGROUND

In the related art, a DisplayPort interface is widely used as a connection interface that connects an electronic apparatus and a peripheral apparatus to each other. DisplayPort is a digital display interface developed by the Video Electronics Standards Association. An apparatus (electronic apparatus is referred to as source apparatus and peripheral apparatus is referred to as sink apparatus) including the DisplayPort interface of a standard specification is spread in general. Meanwhile, the number of users dealing with the source apparatus in which a pin assignment of a connector is customized, the sink apparatus corresponding thereto, a connection cable, or the like also increases.

However, a customized source apparatus equivalent to the general standard can be connected to a non-compatible sink apparatus including a general connection cable or a general connector. In a case where such non-compatible merchandise is connected to the customized source apparatus by mistake, there is a possibility that the failure of damage, malfunction, or the like occurs. Therefore, a countermeasure for incorrect connection that the non-compatible merchandise is connected to the customized source apparatus is required.

### DESCRIPTION OF THE DRAWINGS

FIG. 1 is a pattern diagram of a source apparatus and a sink apparatus, and a connection cable that connects between these apparatuses according to an embodiment.

FIG. 2 is a diagram illustrating an example of a hardware block of the source apparatus.

FIG. 3 is a schematic front view of a terminal connection unit of a first connector.

FIG. 4 is an explanatory diagram of an identification circuit.

FIG. 5 is a diagram illustrating an example of a hardware block of the sink apparatus.

FIG. 6 is a diagram illustrating an example of a pin assignment of first and second connectors, and wiring of a connection cable.

FIG. 7 is a configuration diagram of an identification signal generation unit configured in a part of the source apparatus, the sink apparatus, and the connection cable.

FIG. 8 is a flowchart illustrating an electrical connection operation of the source apparatus.

FIG. 9 is a diagram illustrating a connection example (part 1) of a case where non-compatible merchandise is connected to the source apparatus.

FIG. 10 is a diagram illustrating a connection example (part 2) of a case where the non-compatible merchandise is connected to the source apparatus.

FIGS. 11A to 11D are diagrams illustrating a connection example (part 3) of a case where the non-compatible merchandise is connected to the source apparatus.

FIG. 12 is a diagram illustrating a connection example (part 4) of a case where the non-compatible merchandise is connected to the source apparatus.

FIG. 13 is a diagram illustrating a connection example (part 5) of a case where the non-compatible merchandise is connected to the source apparatus.

### DETAILED DESCRIPTION

Provided herein are an electronic apparatus and a peripheral apparatus capable of preventing electrical failure in a case where non-compatible merchandise is connected.

An electronic apparatus of an embodiment includes a first connector that includes a plurality of terminals including a detection signal output terminal for outputting a detection signal and an identification signal input terminal for receiving an identification signal; a connection cable that connects the detection signal output terminal and the identification signal input terminal to a corresponding terminal of a peripheral apparatus by cross wiring; and a control unit that monitors an input signal of the identification signal input terminal by supplying the detection signal to the detection signal output terminal, and starts signal transmission or electrical power transmission through a remaining terminal in a condition where the identification signal is input to the identification signal input terminal based on the detection signal.

Hereinafter, an embodiment of an electronic apparatus and a peripheral apparatus will be described in detail with reference to the drawings. In the embodiment, as an example of the electronic apparatus, a source apparatus in which a DisplayPort interface is included in a connection interface will be described. In addition, as an example of the peripheral apparatus, a sink apparatus in which the DisplayPort interface is included in a connection interface will be described.

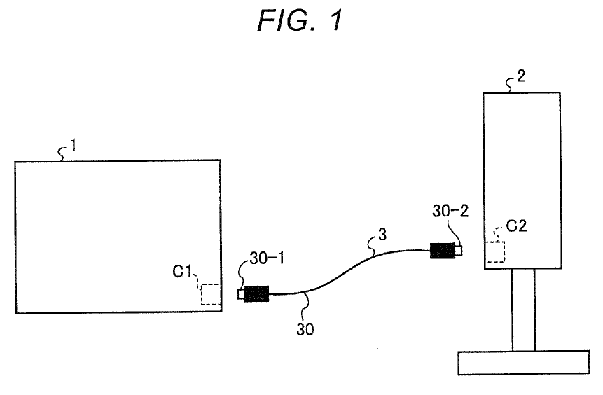

FIG. 1 is a pattern diagram of the source apparatus and the sink apparatus, and a connection cable that connects between these apparatuses. A source apparatus 1 illustrated in FIG. 1 is a PC or the like, and a sink apparatus 2 is the peripheral apparatus (liquid crystal display or the like) thereof. Both the source apparatus 1 and the sink apparatus include the DisplayPort interface. Each connector (respectively, first connector C1 and second connector C2) of the source apparatus 1 and the sink apparatus 2 are connectors of a standard shape of the DisplayPort standard. The pin assignment indicating a correspondence relationship between a pin terminal and a signal name of an electrical wire connected thereto is different from a pin assignment of the standard specification by customization.

A connection cable 3 is configured by customizing the connection cable of the standard specification of the DisplayPort standard. The standard was created by the Video Electronics Standards Association of San Jose, Calif., and is hereby incorporated by reference. The connection cable 3 includes an electrical wire for transmitting a video signal, a control signal, a detection and identification signal, electrical power for power supply, or the like, to a cable unit 30, and includes plugs 30-1 and 30-2 of the standard specification of the DisplayPort standard in both ends of the cable unit 30. The connection cable 3 is obtained by customizing the wiring of each electrical wire of the cable unit 30 based on the standard specification, according to the customization of the pin assignment in each of connectors C1 and C2 of the source apparatus 1 and the sink apparatus 2. A transmission path of the detection and identification signal is formed between the source apparatus 1 and the sink apparatus 2, by connecting the plugs 30-1 and 30-2 of the connection cable 3 to connectors C1 and C2 of the source apparatus 1 and the sink apparatus 2, respectively.

Hereinafter, by exemplifying the liquid crystal display as an example of the sink apparatus 2, a configuration according to the DisplayPort interface of the source apparatus 1 and the sink apparatus 2 will be mainly described. First, a hardware configuration of the source apparatus 1 will be described.

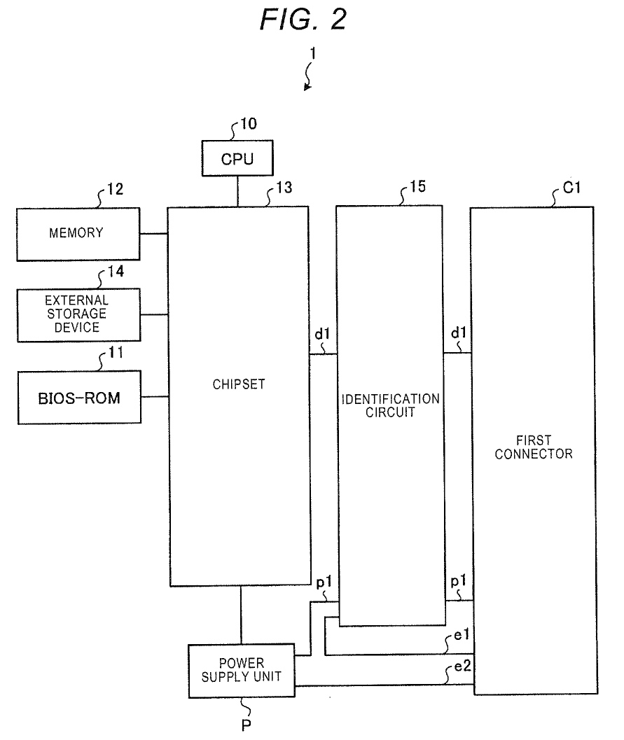

FIG. 2 is a diagram illustrating an example of a hardware block of the source apparatus 1. As illustrated in FIG. 2, the source apparatus 1 includes a CPU 10, a BIOS-ROM 11, a memory 12, a chipset 13, an external storage device 14, an identification circuit 15, the first connector C1, and a power supply unit P.

The CPU 10 is a central processing unit, and performs arithmetic processing or control processing of each unit, by executing various programs of the BIOS-ROM 11 or the external storage device 14.

The BIOS-ROM 11 is a read only memory (ROM) for storing a basic input and output system (BIOS).

The memory 12 is a random access memory (RAM) used as an operation region at the time of executing various programs by the CPU 10.

The external storage device 14 is a hard disk drive (HDD), a flash ROM, or the like. The external storage device 14 stores an operating system (OS), a driver for controlling each unit, an application program, or the like.

The chipset 13 controls the memory, an I/O apparatus, or the like, under the control of the CPU 10. In this example, the chipset 13 controls transmission of the video signal, the control signal, the detection and identification signal, the electrical power, or the like, to the sink apparatus 2 that is the I/O apparatus, as a circuit equivalent to the DisplayPort standard.

The identification circuit 15 is a circuit for identifying that compatible merchandise (connection cable 3 and sink apparatus 2) of its own device is connected to the first connector C1 of the DisplayPort standard. In this example, the identification circuit 15 intervenes inside each transmission path of a signal transmission path d1 for connecting the chipset 13 and the first connector C1 to each other, and an electrical power transmission path p1 for connecting the power supply unit P and the first connector C1 to each other. The identification circuit 15 can identify that the compatible merchandise of its own device is connected to the first connector C1, and start the transmission of a signal or the electrical power through the signal transmission path d1 or the electrical power transmission path p1.

The first connector C1 is a receptacle conforming to the DisplayPort standard, and includes 20 pin terminals.

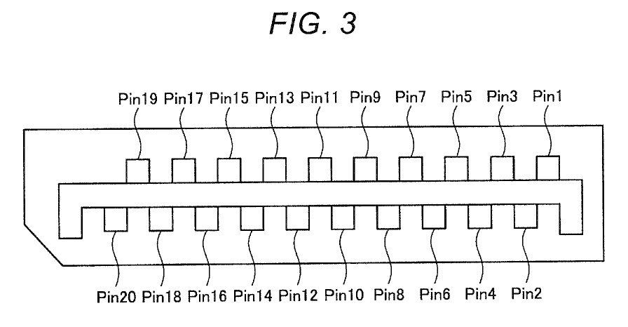

FIG. 3 is a schematic front view of the terminal connection unit of the first connector C1. Pin numbers (Pin 1 to Pin 20) are denoted to the pin terminals of the first connector C1. The first connector C1 illustrated in FIG. 3 is a connector of which the outer shape conforms to the DisplayPort standard. A standard plug of the DisplayPort standard can be connected to the first connector C1.

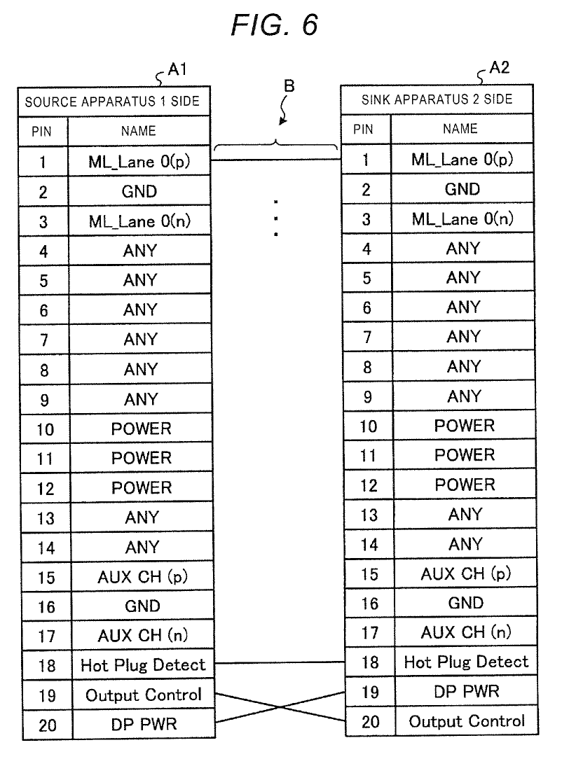

Each electrical wire of the signal transmission paths d1 for transmitting the video signal, the control signal, or the like of the chipset 13 (see FIG. 2) is connected to each of the pin terminals (Pin 1 to Pin 20) of the first connector C1, through the identification circuit 15 (see FIG. 2). In addition, an electrical wire of the electrical power transmission path p1 for supplying the electrical power from the power supply unit P (see FIG. 2) through the identification circuit 15 to external is connected. In addition, an electrical wire of an identification signal transmission path e1 for transmitting an identification signal to the identification circuit 15 is connected. In addition, an electrical wire of a detection signal transmission path e2 for transmitting a detection signal of the power supply unit P is connected. The pin assignment indicating a correspondence relationship of each pin terminal and a signal name of the electrical wire connected to respective paths is different from that of the standard specification. The pin assignment of the first connector C1 will be described below by using FIG. 6.

The power supply unit P (see FIG. 2) is a power supply circuit for supplying the electrical power. For example, the power supply unit P includes a rectifier circuit, a voltage conversion circuit, or the like, and supplies the electrical power such as commercial power supply, or the like to each unit of its own device. In addition, the power supply unit P supplies the operation electrical power of the sink apparatus 2 to a corresponding pin terminal (corresponding terminal) of the first connector C1, through a part of the identification circuit 15. Furthermore, the power supply unit P supplies a voltage of (+) 3.3 V to a corresponding pin terminal (corresponding terminal) of the first connector C1. The voltage of (+) 3.3 V is supplied as a detection signal for detecting that the compatible merchandise is connected.

Here, an example of the identification circuit 15 is represented.

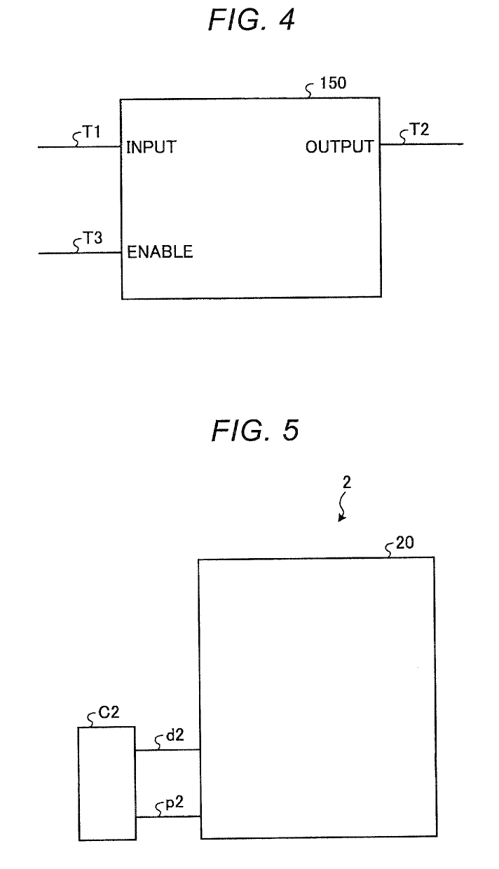

FIG. 4 is an explanatory diagram of the identification circuit 15. A circuit 150 of FIG. 4 is configured by a logic element or the like, and includes an input terminal T1, an output terminal T2, and an enable terminal T3. An electrical wire of the input side of signals or the electrical power transmitted through the first connector C1 is connected to the input terminal T1. An electrical wire of the output side of the signals or the electrical power input to the input terminal T1 is connected to the output terminal T2. For example, an electrical wire of the video signal output from the chipset 13 with respect to the video signal is connected to the input terminal T1, and the output terminal T2 thereof is connected to a corresponding terminal and an electrical wire of the video signal of the first connector C1. The enable terminal T3 is connected to an identification pin terminal and an electrical wire of the first connector C1.

The operation of the circuit 150 is as follows. The circuit 150 outputs the input signal of the input terminal T1 from the output terminal T2, in a state where an ON signal (identification signal) is input to the enable terminal T3. The circuit 150 stops outputting from the output terminal T2 of the input signal of the input terminal T1, in a state where an OFF signal (identification signal) is input to the enable terminal T3. In this example, the “ON signal” is set as the voltage of a High level exceeding a predetermined threshold voltage, and the “OFF signal” is set as the voltage of a Low level such as “0 V (voltage)” and the like. In addition, in a state where the OFF signal is input, the circuit 150 outputs the signal of 0 V from the output terminal T2.

The identification circuit 15 includes the configuration illustrated as the circuit 150 for each of the electrical wires of the signal transmission path d1 or the electrical power transmission path p1 of the electrical power for transmitting signals through the first connector C1.

Next, a configuration of the sink apparatus 2 will be described.

FIG. 5 is a diagram illustrating an example of a hardware block of the sink apparatus 2. As illustrated in FIG. 5, the sink apparatus 2 includes a display device (processing unit) 20 and the second connector C2.

The display device 20 is a display device of the DisplayPort standard. The display device 20 is operated by receiving supply of the electrical power from a predetermined pin terminal of the second connector C2. The display device 20 receives the control signal or the video signal through the predetermined pin terminal of the second connector C2, and displays an image based on the received video signal on a display panel.

The second connector C2 is a receptacle conforming to the DisplayPort standard, and includes 20 pin terminals. Each of the electrical wires of signal transmission paths d2, the electrical wire of an electrical power transmission path p2, and the like of the video signal, the control signal, or the like of the display device 20 side is connected to the pin terminal. The pin assignment indicating correspondence relationship between respective pin terminals and signal names of electrical wires connected to the respective pin terminals is different from that of the standard specification. The pin assignment of the first connector C1 and the pin assignment of the second connector C2 will be described below.

FIG. 6 is a diagram illustrating an example of a pin assignment A1 of the first connector C1 of the source apparatus 1, a pin assignment A2 of the second connector C2 of the sink apparatus 2, and wiring B of the connection cable 3 connected thereto, in the embodiment.

The source apparatus 1 is configured by customizing the connection relationship of an electrical wire connected to the pin terminal from an apparatus of the standard specification. Specifically, in the source apparatus 1, terminals of the pin number 10 to the pin number 12 used in one of the four lanes in the standard specification are connected to the electrical wire of the electrical power transmission path p1 of the power supply unit P as illustrated in FIG. 6 as “POWER”, by the customization. Furthermore, in the source apparatus 1, the terminal of the pin number 19 used as “Return” in the standard specification is connected to the enable terminal T3 (see FIG. 4) as illustrated in FIG. 6 as “Output Control”.

It is also possible to appropriately customize the pin number 4 to the pin number 9, the pin number 13, and the pin number 14. For example, a pin terminal for transmitting signals of a USB device may be assigned to any one of these pin terminals. Here, in order to simplify the description, an example of a specific signal name or the like with respect to these pin numbers is omitted. In FIG. 6, “ANY” indicating that there may be arbitrary assignment is represented.

The connection cable 3 is configured by customizing wiring of each electrical wire from the plug 30-1 to the plug 30-2 based on the standard specification. Specifically, the connection cable 3 is configured by connecting terminals of the pin number 1 to the pin number 18 of both the first connector C1 of the source apparatus 1 and the second connector C2 of the sink apparatus 2 by using the straight wiring rather than the cross wiring of the standard specification. Furthermore, the connection cable 3 is configured by connecting the terminals of the pin number 19 and the pin number 20 by using the cross wiring rather than the straight wiring of the standard specification.

The sink apparatus 2 is also configured by customizing a connection relationship of the electrical wire connected to the pin terminal based on the standard specification, according to the customization content of the source apparatus 1 or the connection cable 3. For example, the connection of terminals of the pin number 1 to the pin number 3 is changed from the connection of the electrical wire of the lane 3 of the standard specification to the connection of the electrical wire of the lane 0.

The description with respect to the above change is as follows. In the standard specification, the terminals of the pin number 1 to the pin number 3 of the second connector C2 are cross-wired with the terminals of the pin number 10 to the pin number 12 of the source apparatus 1 side. The terminals of the pin number 10 to the pin number 12 of the source apparatus 1 side are the lane 3 in the standard specification. Therefore, the terminals of the pin number 1 to the pin number 3 of the second connector C2 are connected to the electrical wire of the lane 3. Meanwhile, according to the customization content of the connection cable 3, the terminals of the pin number 1 to the pin number 3 of the second connector C2 are straight-wired with the terminals of the pin number 1 to the pin number 3 of the source apparatus 1. The terminals of the pin number 1 to the pin number 3 of the source apparatus 1 are lane 0. Therefore, the terminals of the pin number 1 to the pin number 3 of the second connector C2 are connected to the electrical wire of the lane 0.

The terminals of the pin number 4 to the pin number 12 are also straight-wired in the connection cable 3. With this, the terminals of the pin number 4 to the pin number 12 of the second connector C2 are connected to the electrical wires corresponding to the terminals of the pin number 4 to the pin number 12 of the source apparatus 1, respectively.

The terminals of the pin number 19 and the pin number 20 are cross-wired to the connection cable 3. The sink apparatus 2 uses the terminals of the pin number 19 and the pin number 20 as a unit for generating the identification signal from the detection signal.

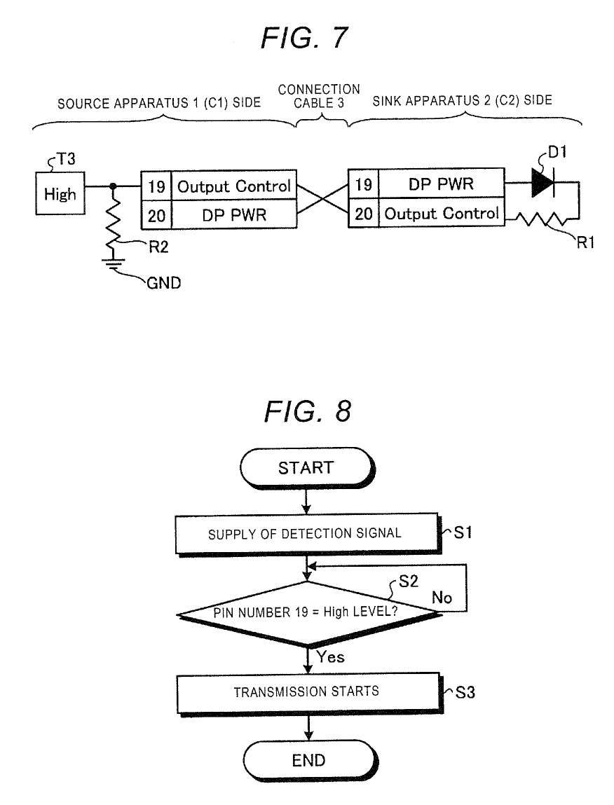

FIG. 7 is a configuration diagram of an identification signal generation unit configured in a part of the source apparatus 1, the sink apparatus 2, and the connection cable 3 according to the embodiment. The terminal of the pin number 20 of the first connector C1 corresponds to a detection signal output terminal, and the terminal of the pin number 19 corresponds to an identification signal input terminal. In addition, the terminal of the pin number 19 of the second connector C2 corresponds to a detection signal input terminal, and the terminal of the pin number 20 corresponds to an identification signal output terminal. As illustrated in FIG. 7, a diode D1 and a limiting resistor R1 connected in series to the diode are connected between the terminal of the pin number 19 and the terminal of the pin number 20 of the second connector C2 of the sink apparatus 2 side, as an identification signal output unit that outputs the identification signal. In addition, in the source apparatus 1 side, the electrical wire for connecting the enable terminal T3 and the terminal of the pin number 19 of the first connector C1 is connected to the ground GND, through a pull-down resistor R2.

The diode D1 is a semiconductor element supplying a current in one direction, and the limiting resistor R1 is a resistor for controlling an operation voltage or current of the diode D1. The pull-down resistor R2 is mainly to ensure a voltage level of the enable terminal T3 to the Low level, in a case where the merchandise is not connected or the non-compatible merchandise is connected with respect to the first connector C1. In the case where the merchandise is not connected or the non-compatible merchandise is connected, voltages of the terminal of the pin number 19 of the first connector C1 and the enable terminal T3 become the ground (0 V (voltage)).

In the connection state illustrated in FIG. 7, the identification signal generation unit is operated as follows. The detection signal (voltage of +3.3 V) is input from the terminal of the pin number 20 of the first connector C1 to the terminal of the pin number 19 of the second connector C2. With this, in the second connector C2, the voltage of +3.3 V is applied to an anode of the diode D1, and a current flows from the terminal of the pin number 19 to the terminal of the pin number 20. The current flows into the enable terminal T3 by passing from the pin number 20 to the terminal of the pin number 19 of the first connector C1 through the connection cable 3. With this, a voltage of the enable terminal T3 increases in an internal circuit of the circuit 150 such that the voltage of the enable terminal T3 becomes the High level.

Next, the electrical connection operation with the sink apparatus by the source apparatus 1 will be described. The source apparatus 1 performs the following electrical connection operation by being operated by the CPU 10, the chipset 13, the identification circuit 15, or the like, as a control unit, and by detecting the plugged connection of the sink apparatus, at the time of starting or after starting, when the compatible merchandise or the non-compatible merchandise is plugged into the first connector C1.

FIG. 8 is a flowchart illustrating the electrical connection operation of the source apparatus 1.

First, the source apparatus 1 supplies the voltage of +3.3 V (detection signal) of the power supply unit P to the terminal of the pin number 20 (S1). For example, the CPU 10 outputs a connection start instruction of the DisplayPort to the chipset 13. The chipset 13 connects a line of the voltage of +3.3 V supplied by the power supply unit P to the terminal of the pin number 20 by turning ON or the like an electronic switch, by the instruction.

Next, the source apparatus 1 determines whether a voltage level of the terminal of the pin number 19 of the first connector C1 is the High level (S2). In the configuration example, the circuit 150 of the identification circuit 15 (see FIG. 4) determines a voltage level of the enable terminal T3 by monitoring the voltage level of the enable terminal T3. When connected merchandise is the compatible merchandise, since the voltage level of the enable terminal T3 is the High level, Yes is determined in step S2. When connected merchandise is the non-compatible merchandise, since a voltage level of the enable terminal T3 is maintained at the Low level at the time of non-connection, No is determined in step S2.

In a case where Yes is determined in step S2, the source apparatus 1 starts transmission of various signals, driving electrical power, or the like, through a certain pin terminal of the first connector C1 (S3). In the configuration example, the circuit 150 outputs the input signal of the input terminal T1 by the input of the High level of the enable terminal T3 to the output terminal T2. With this, the transmission to the inside or outside of the source apparatus 1 of the video signal, the control signal, the electrical power, or the like transmitted and received with the sink apparatus 2 can be performed, and the source apparatus 1 starts transmission and reception with the sink apparatus 2.

Meanwhile, in a case of No determination in step S2, an input voltage of the enable terminal T3 is maintained at the Low level. With this, the circuit 150 maintains the output of the output terminal T2 to 0 V, without passing through the input signal of the input terminal T1. That is, in the configuration example, the source apparatus 1 can stop in advance the transmission to the inside or outside of the source apparatus 1 of the video signal, the control signal, the electrical power, or the like transmitted and received with a non-compatible apparatus. The source apparatus 1 repeats the determination of step S2 until the voltage level of the enable terminal T3 is changed to the High level. Accordingly, when the non-compatible merchandise is exchanged to the compatible merchandise, the voltage level of the enable terminal T3 becomes the High level, and Yes is determined in step S2. After Yes determination in step S2, the source apparatus 1 starts the transmission of step S3, and completes the operation at the time of electrical connection.

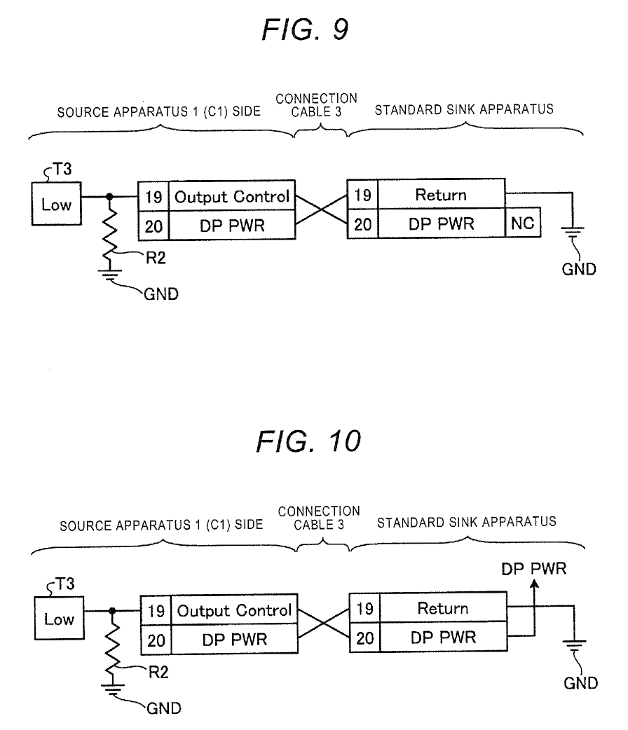

Here, a connection example of a case where the non-compatible merchandise is connected to the first connector C1 of the source apparatus 1 is represented. FIG. 9 to FIG. 13 are diagrams illustrating the connection example of a case where the non-compatible merchandise is connected to the source apparatus 1. However, in each diagram, a configuration excluding a portion relating to the identification signal generation unit will be omitted in order to compare with FIG. 7.

FIG. 9 is a connection example of a case where a standard sink apparatus (there is no power option of standard specification) that is the non-compatible merchandise is connected through the connection cable 3. In this case, the terminal (DP PWR) of the pin number 20 of the source apparatus 1 side and the terminal (Return) of the pin number 19 of the standard sink apparatus side are connected to each other. In addition, the terminal of the pin number 19 of the source apparatus 1 side (Output Control) and the terminal (DP PWR) of the pin number 20 of the standard sink apparatus side are connected to each other. The terminal of the pin number 20 of the standard sink apparatus side is the non-connection (NC) because of no power option.

In the connection example, the terminal of the pin number 19 of the source apparatus 1 becomes 0 V of the ground GND connected through the pull-down resistor R2. Accordingly, the input voltage of the enable terminal T3 is maintained at the Low level before the connection, and the source apparatus 1 does not start the transmission of the video signal, the control signal, the electrical power, or the like with the standard sink apparatus by outputting or the like 0 V to the output terminal T2. In addition, in the standard sink apparatus side, the terminal (Return) of the pin number 19 becomes the ground GND. Therefore, the source apparatus 1 suppresses flowing of a current to an internal circuit of the standard sink apparatus by the voltage of (+) 3.3 V output from the terminal of the pin number 20 as the detection signal.

FIG. 10 is a connection example of a case where the standard sink apparatus is changed to an apparatus having the power option of the standard specification in the connection example of FIG. 9. The terminal (DP PWR) of the pin number 20 of the standard sink apparatus side is connected to a line, to which a driving voltage from the source apparatus 1 is supplied, of a predetermined circuit included in the standard sink apparatus side. In addition, in the connection example, the terminal of the pin number 19 of the source apparatus 1 becomes 0 V of the ground GND connected through the pull-down resistor R2. Accordingly, the input voltage of the enable terminal T3 is maintained at the Low level before the connection, and the source apparatus 1 does not start the transmission. In addition, since an input voltage with respect to the terminal (DP PWR) of the pin number 20 of the standard sink apparatus side becomes 0 V, effect on the internal circuit of the standard sink apparatus by the connection is suppressed.

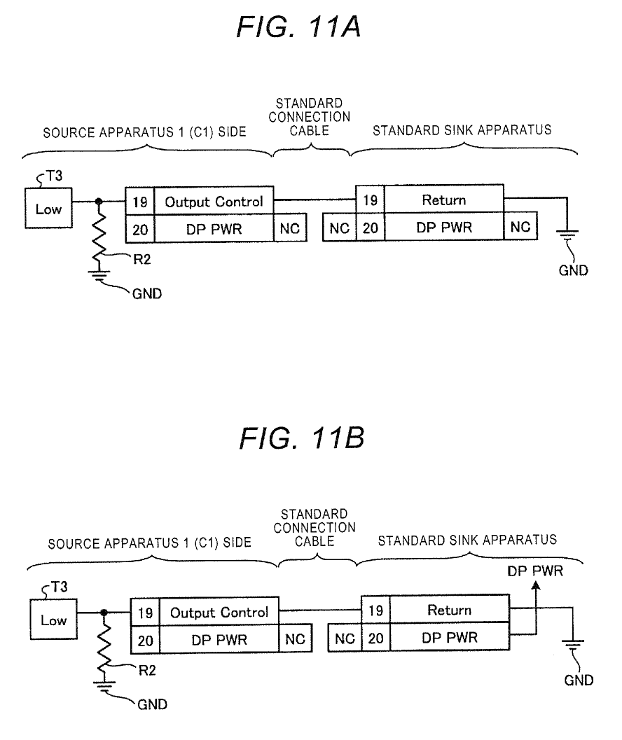

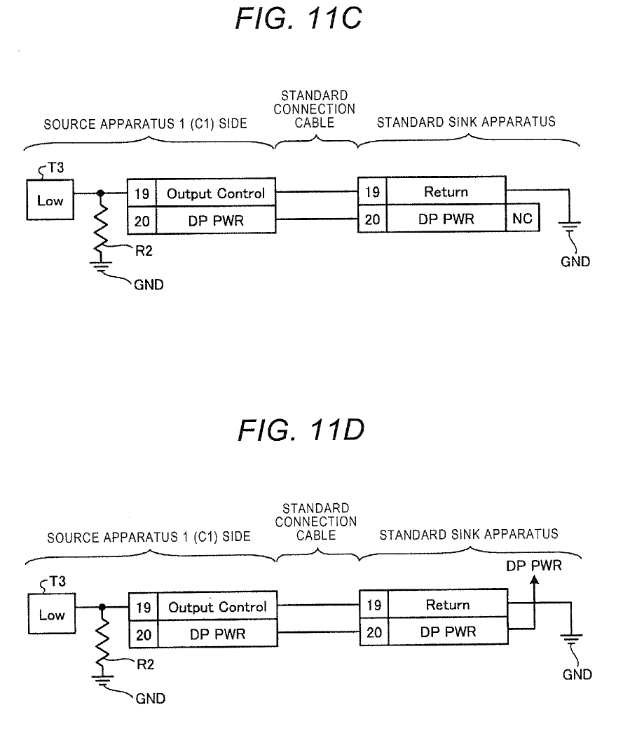

FIGS. 11A to 11D are connection examples of a case where the standard sink apparatus that is the non-compatible merchandise is connected through the standard DisplayPort cable that is also the non-compatible merchandise.

FIG. 11A is a connection example of a case where the standard sink apparatus (there is no power option of standard specification) is connected through the standard DisplayPort cable (there is no power option of standard specification). In this case, the terminal (Output Control) of the pin number 19 of the source apparatus 1 side and the terminal (Return) of the pin number 19 of the standard sink apparatus side are connected to each other. The terminal (DP PWR) of the pin number 20 of the source apparatus 1 side and the terminal (DP PWR) of the pin number 20 of the standard sink apparatus side are not connected to each other. Furthermore, the terminal (DP PWR) of the pin number 20 of the standard sink apparatus side is not connected to the internal circuit.

In addition, in the connection example, since the terminal (Return) of the pin number 19 of the standard sink apparatus side becomes the ground GND, the terminal of the pin number 19 of the source apparatus 1 becomes 0 V. Accordingly, the input voltage of the enable terminal T3 is maintained at the Low level before the connection, and the source apparatus 1 does not start the transmission. In addition, since the terminal of the pin number 20 of the source apparatus 1 side and the terminal of the pin number 20 of the standard sink apparatus side are not connected to each other, the voltage of (+) 3.3 Vas the detection signal is not input to the standard sink apparatus side.

FIG. 11B is a connection example of a case where the standard sink apparatus is changed to an apparatus having a power option in the connection example of FIG. 11A. Also, in the connection example, the input voltage of the enable terminal T3 is maintained at the Low level before the connection, and the source apparatus 1 does not start the transmission, similar to the connection example of FIG. 11A. In addition, since the terminal of the pin number 20 of the source apparatus 1 side and the terminal of the pin number 20 of the standard sink apparatus side are not connected to each other, the voltage of (+) 3.3 Vas the detection signal is not input to the standard sink apparatus side.

FIG. 11C is a connection example of a case where the standard DisplayPort cable is changed to an apparatus having the power option in the connection example of FIG. 11A. In this case, the terminal (Output Control) of the pin number 19 of the source apparatus 1 side and the terminal (Return) of the pin number 19 of the standard sink apparatus side are connected to each other. In addition, the terminal (DP PWR) of the pin number 20 of the source apparatus 1 side and the terminal (DP PWR) of the pin number 20 of the standard sink apparatus side are connected to each other. The terminal (DP PWR) of the pin number 20 of the standard sink apparatus side is not connected to the internal circuit. Also, in the connection example, the input voltage of the enable terminal T3 is maintained at the Low level before the connection and the source apparatus 1 does not start the transmission, similar to the connection example of FIG. 11A. In addition, since the terminal (DP PWR) of the pin number 20 of the standard sink apparatus side is not connected to the internal circuit, the voltage of (+) 3.3 V as the detection signal is not input to the internal circuit of the standard sink apparatus.

FIG. 11D is a connection example of a case where the standard DisplayPort cable and the standard sink apparatus are changed to an apparatus having the power option in the connection example of FIG. 11A. In this case, the terminal (DP PWR) of the pin number 20 of the standard sink apparatus side is connected to a line, to which a driving voltage from the source apparatus 1 is supplied, of a predetermined circuit included in the standard sink apparatus side. Also, in the connection example, the input voltage of the enable terminal T3 is maintained at the Low level before the connection and the source apparatus 1 does not start the transmission, similar to the connection example of FIG. 11A. In addition, since the terminal (DP PWR) of the pin number 20 of the standard sink apparatus side only supplies the prescribed voltage of +3.3 V to the internal circuit of the standard sink apparatus, effect to the internal circuit of the standard sink apparatus side can be suppressed.

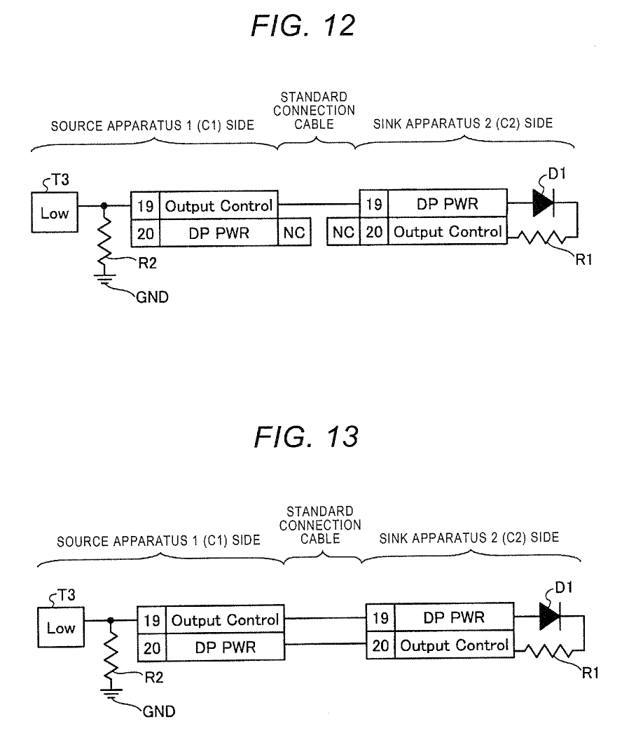

FIG. 12 and FIG. 13 are connection examples of a case where the sink apparatus 2 that is the compatible merchandise is connected through the standard DisplayPort cable that is the non-compatible merchandise.

FIG. 12 is a connection example of a case of the standard DisplayPort cable (there is no power option of standard specification). In this case, the terminal (Output Control) of the pin number 19 of the source apparatus 1 side and the terminal (DP PWR) of the pin number 19 of the sink apparatus 2 side are connected to each other. The terminal (DP PWR) of the pin number 20 of the source apparatus 1 side and the terminal (Output Control) of the pin number 20 of the sink apparatus 2 side are not connected to each other. In the connection example, the terminal of the pin number 19 of the source apparatus 1 becomes 0 V of the ground GND. Therefore, the input voltage of the enable terminal T3 is maintained at the Low level before the connection, and the source apparatus 1 does not start the transmission.

FIG. 13 is a connection example of a case of the standard DisplayPort cable (there is power option of standard specification). In this case, the terminal (DP PWR) of the pin number 20 of the source apparatus 1 side and the terminal (Output Control) of the pin number 20 of the sink apparatus 2 side are connected to each other. With this, the voltage of +3.3 V is applied to the terminal (Output Control) of the pin number 20 of the sink apparatus 2 side. However, since the diode D1 suppresses a reverse current, a current flowing from the terminal of the pin number 20 to the terminal of the pin number 19 is not generated in the sink apparatus 2 side. Therefore, the terminal of the pin number 19 of the source apparatus 1 becomes 0 V of the ground GND. Since the input voltage of the enable terminal T3 is maintained at the Low level before the connection, the source apparatus 1 does not start the transmission.

In the embodiment, the video signal is exemplified as an example of a transmission signal between the source apparatus and the sink apparatus. However, this invention is not limited thereto, and may transmit other signals such as an audio signal and the like.

In addition, in the embodiment, the transmission of the signal or the electrical power from the source apparatus to the sink apparatus is mainly exemplified. Needless to say, transmission from the sink apparatus to the source apparatus may also be implemented. For example, if the sink apparatus includes the USB device such as the touch panel and the like, a configuration in which the source apparatus receives a signal from the USB device may be also implemented.

In addition, in the embodiment, the identification circuit in which an enable signal as the identification signal is input to the enable terminal is exemplified. However, the identification circuit is not limited thereto. If the circuit switches ON and OFF of the output of the input signal such as the video signal or the like, appropriate modification may be implemented.

In addition, an example in which the identification circuit is provided in the source apparatus is exemplified. However, a part or the entirety of the identification circuit may be provided in the connection cable.

In addition, in the embodiment, the circuit including a diode as a circuit that passes through a current in one direction is exemplified. However, the circuit is not limited thereto. For example, a semiconductor element of a transistor (FET or the like) may be used.

In addition, in the embodiment, the connection example of the PC and the liquid crystal display is exemplified as the connection example of the source apparatus and the sink apparatus. However, a combination of the source apparatus and the sink apparatus is not limited thereto. For example, the source apparatus may be also implemented as a POS terminal or the like, and the sink apparatus may be also implemented as a projector or the like.

In addition, the DisplayPort interface of the embodiment may be also applied to an interface of a configuration of a mini plug.

In addition, this invention is not limited to the DisplayPort standard, and may be also appropriately applied to other standards.

As described above, in the embodiment, even in a case where the general purpose standard interface such as the DisplayPort connects by mistake the non-compatible merchandise to the customized source apparatus 1, it is possible to stop the transmission of the video signal, the control signal, the electrical power, or the like between the source apparatus 1 and a non-compatible sink apparatus. That is, it is possible to prevent electrical failure of a case where the non-compatible merchandise is connected.

While certain embodiments have been described with respect to the configuration of the electronic apparatus and the peripheral apparatus, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a first connector comprising a plurality of terminals including a detection signal output terminal for outputting a detection signal and an identification signal input terminal for receiving an identification signal;
a connection cable connecting the detection signal output terminal and the identification signal input terminal to a corresponding terminal of a peripheral apparatus by cross wiring; and
a control unit that monitors an input signal of the identification signal input terminal by supplying the detection signal to the detection signal output terminal, and starts signal transmission or electrical power transmission through a remaining terminal in a condition where the identification signal is input to the identification signal input terminal based on the detection signal.

2. The electronic apparatus according to claim 1,
wherein the detection signal output terminal is set as a voltage supplying terminal.

3. A peripheral apparatus connected to the apparatus according to claim 1 through a connection cable, the peripheral apparatus comprising:
a second connector comprising a detection signal input terminal for receiving a detection signal and an identification signal output terminal for outputting an identification signal, and comprising corresponding terminals of a plurality of terminals;
an identification signal output unit outputting the identification signal to the identification signal output terminal in a condition where the detection signal is input from the detection signal input terminal; and
a processing unit that performs signal transmission or electrical power transmission through a remaining terminal of the second connector.

4. The peripheral apparatus according to claim 3,
wherein the second connector is a connector of DisplayPort standard, and
wherein the detection signal input terminal is provided in a terminal of the same pin number as a terminal used in ground in the standard specification.

5. The peripheral apparatus according to claim 3,
wherein the identification signal output unit includes a semiconductor element for outputting the identification signal by an input from a predetermined direction of the detection signal.

6. The peripheral apparatus according to claim 4,
wherein the identification signal output unit includes a semiconductor element for outputting the identification signal by an input from a predetermined direction of the detection signal.

7. A peripheral apparatus for connection to an electronic apparatus through a connection cable, comprising:
a first connector comprising a detection signal input terminal for receiving a detection signal and an identification signal output terminal for outputting an identification signal, and comprising corresponding terminals of a plurality of terminals;
an identification signal output unit outputting the identification signal to the identification signal output terminal in a condition where the detection signal is input from the detection signal input terminal; and
a processing unit that performs signal transmission or electrical power transmission through a remaining terminal of the first connector.

8. The peripheral apparatus according to claim 7,
wherein the first connector is a connector of DisplayPort standard, and
wherein the detection signal input terminal is provided in a terminal of the same pin number as a terminal used in ground in the standard specification.

9. The peripheral apparatus according to claim 7,
wherein the identification signal output unit includes a semiconductor element for outputting the identification signal by an input from a predetermined direction of the detection signal.

10. The peripheral apparatus according to claim 8,
wherein the identification signal output unit includes a semiconductor element for outputting the identification signal by an input from a predetermined direction of the detection signal.

11. An electronic apparatus connected to the peripheral apparatus according to claim 7 comprising:
a second connector comprising a plurality of terminals including a detection signal output terminal for outputting a detection signal and an identification signal input terminal for receiving an identification signal;
a connection cable connecting the detection signal output terminal and the identification signal input terminal to a corresponding terminal of the peripheral apparatus by cross wiring; and
a control unit that monitors an input signal of the identification signal input terminal by supplying the detection signal to the detection signal output terminal, and starts signal transmission or electrical power transmission through a remaining terminal in a condition where the identification signal is input to the identification signal input terminal based on the detection signal.

12. The electronic apparatus according to claim 11,
wherein the detection signal output terminal is set as a voltage supplying terminal.

13. An interface method for the electronic apparatus of claim 1, comprising:
supplying a detection signal to the detection signal output terminal;
outputting the detection signal by the detection signal output terminal;
receiving an identification signal by the identification signal input terminal;
monitoring an input signal of the identification signal input terminal;
initiating signal transmission or electrical power transmission through a remaining terminal in a condition where the identification signal is input to the identification signal input terminal based on the detection signal.

14. The method according to claim 13, further comprising:
setting the detection signal output terminal as a voltage supplying terminal.

15. The method according to claim 13, further comprising:
receiving a detection signal by a detection signal input terminal;
outputting an identification signal by an identification signal output terminal;
an identification signal output unit that
outputting the identification signal to the identification signal output terminal in a condition where the detection signal is input from the detection signal input terminal; and
performing signal transmission or electrical power transmission through a remaining terminal of the second connector.

16. The method according to claim 15,
wherein the interface method is in accordance with a DisplayPort standard.

17. The method according to claim 15, further comprising:
outputting the identification signal by an input from a predetermined direction of the detection signal.

18. The apparatus according to claim 16, further comprising:
outputting the identification signal by an input from a predetermined direction of the detection signal.
